(19) United States
(12) Patent Application Publication
(10) Pub. No.: US 2023/0007135 A1
(43) Pub. Date: Jan. 5, 2023

(54) IMAGE FORMING APPARATUS

(71) Applicant: TOSHIBA TEC KABUSHIKI KAISHA, Tokyo (JP)

(72) Inventor: Hiroyuki Kato, Mishima Shizuoka (JP)

(21) Appl. No.: 17/748,061

(22) Filed: May 19, 2022

(30) Foreign Application Priority Data
Jul. 2, 2021 (JP) 2021-110864

(51) Int. Cl. H04N 1/00; H04N 1/44

(52) U.S. Cl. CPC H04N 1/00403; H04N 1/00915; H04N 1/00488; H04N 1/442

(57) ABSTRACT

According to one embodiment, an image forming apparatus includes a voice input interface and a processor. The voice input interface is configured to acquire an input voice input through a microphone. The processor is configured to recognize a content of a job instructed by voice from the input voice acquired by the voice input interface and to identify a speaker from the input voice and, if voices output from a plurality of speakers in the same period are acquired, configured to set an execution order of a plurality of jobs that are recognized from the voices output from the speakers and to execute the jobs in the set execution order.

### CROSS-REFERENCE TO RELATED APPLICATION

This application is based upon and claims the benefit of priority from Japanese Patent Application No. 2021-110864, filed on Jul. 2, 2021, the entire contents of which are incorporated herein by reference.

### FIELD

Embodiments described herein relate generally to an image forming apparatus, a method for an image forming apparatus, and an image forming system.

### BACKGROUND

In the related art, regarding an image forming apparatus such as a digital multi-functional peripheral, a voice operation system that executes an execution instruction of a job by voice using voice recognition is disclosed. However, the voice operation system that is applied to the image forming apparatus in the related art does not have a function of identifying a speaker who executes a voice operation in many cases. Therefore, the image forming apparatus such as a digital multi-functional peripheral to which the voice operation system is applied has a problem in that any one can instruct to execute a job by voice.

In addition, by providing a function of identifying users to the voice operation system, usage authority can be checked for the individual users. However, if an image forming apparatus receives instructions by voice, a case where a plurality of users instruct the image forming apparatus to execute a plurality of different jobs in the same period is more likely to occur. Therefore, it is desired that an image forming apparatus that can smoothly process a plurality of jobs instructed by a plurality of users even if the users instruct the image forming apparatus to execute the jobs in the same period by voice.

### DESCRIPTION OF THE DRAWINGS

FIG. 1 is a block diagram illustrating a configuration example of a digital multi-functional peripheral as an image forming apparatus according to an embodiment;

FIG. 2 is a diagram illustrating a configuration example of a processing system including the digital multi-functional peripheral as the image forming apparatus;

FIG. 3 is a diagram illustrating a configuration example of a user information database stored in the digital multi-functional peripheral as the image forming apparatus;

FIG. 4 is a diagram illustrating a configuration example of a function database that stores information regarding a voice execution function stored in the digital multi-functional peripheral as the image forming apparatus;

FIG. 5 is a flowchart illustrating a registration process of the voice execution function by the digital multi-functional peripheral as the image forming apparatus; and

FIG. 6 is a flowchart illustrating an execution process of a job corresponding to a voice instruction by the digital multi-functional peripheral as the image forming apparatus.

### DETAILED DESCRIPTION

Embodiments provide an image forming apparatus that can smoothly process jobs instructed by users by voice.

In general, according to one embodiment, an image forming apparatus includes a voice input interface and a processor. The voice input interface is configured to acquire an input voice input through a microphone. The processor is configured to recognize a content of a job instructed by voice from the input voice acquired by the voice input interface and to identify a speaker from the input voice and, if voices output from a plurality of speakers in the same period are acquired, configured to set an execution order of a plurality of jobs that are recognized from the voices output from the speakers and to execute the jobs in the set execution order.

Hereinafter, an embodiment will be described with reference to the drawings.

First, a configuration of a digital multi-functional peripheral (MFP) 1 as an image forming apparatus according to the embodiment will be described.

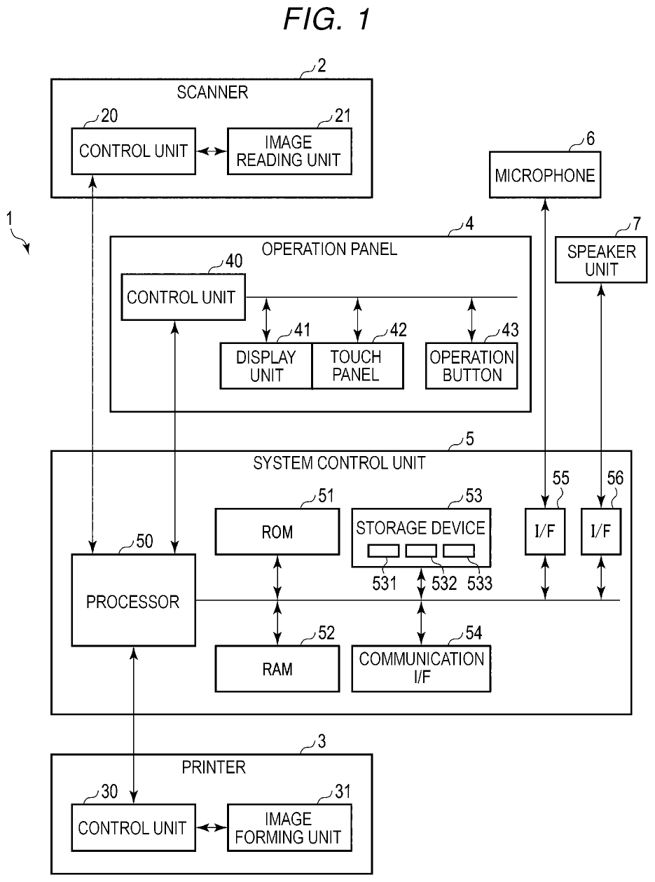

FIG. 1 is a block diagram illustrating a configuration example of the digital multi-functional peripheral 1 as the image forming apparatus according to the embodiment.

As illustrated in FIG. 1, the digital multi-functional peripheral 1 includes a scanner 2, a printer 3, and an operation panel 4. Further, the digital multi-functional peripheral 1 includes a microphone 6 that inputs a voice and a speaker unit 7 that outputs a voice.

The scanner 2 is provided in a main body upper portion of the digital multi-functional peripheral. The scanner 2 is a device that optically reads an image of a document. The scanner 2 includes a control unit 20 and an image reading unit 21. The image reading unit 21 reads an image of a document set on a document table glass. In addition, the image reading unit 21 reads an image of a document that is conveyed by an automatic document feeder (ADF).

The control unit 20 of the scanner 2 controls the scanner 2. The control unit 20 is configured with a processor, a memory, and the like. The control unit 20 executes various processes by the processor executing programs stored in the memory. For example, the control unit 20 causes the image reading unit 21 to execute a scanning process in response to an operation instruction from a system control unit 5.

The printer 3 forms an image on a medium such as paper. The printer 3 includes a control unit 30 and an image forming unit 31. The image forming unit 31 forms an image on paper picked up from a paper feed cassette. The image forming unit 31 may form an image using any image forming method. For example, in an electrophotographic method, the image forming unit 31 forms a developer image on an image carrier such as a photoconductive drum and transfers the developer image on the image carrier to the medium. In addition, in an ink jet method, the image forming unit 31 forms an image on paper with ink ejected from an ink jet head.

The control unit 30 of the printer 3 controls the printer 3. The control unit 30 is configured with a processor, a memory, and the like. The control unit 30 executes various processes by the processor executing programs stored in the memory. For example, the control unit 30 causes the image forming unit 31 to execute an image forming process (printing process) in response to an operation instruction from the system control unit 5.

The operation panel 4 is a user interface. The operation panel 4 includes a control unit 40, a display unit (display) 41, a touch panel 42, and an operation button 43. The display unit 41 displays an operation guide or the like. The touch panel 42 is provided on a display screen of the display unit 41. The touch panel 42 detects a portion touched by a user on the display screen of the display unit 41.

The control unit 40 of the operation panel 4 controls the operation panel 4. The control unit 40 is configured with a processor, a memory, and the like. The control unit 40 executes various processes by the processor executing programs stored in the memory. For example, the control unit 40 controls the display of the display unit 41 in response to an instruction from the system control unit 5.

The system control unit 5 controls the entire MFP 1. The system control unit 5 includes a processor 50, a ROM 51, a RAM 52, a storage device 53, a communication interface (I/F) 54, an interface 55, and an interface 56.

The processor 50 executes various processing functions by executing programs. The processor 50 is, for example, a CPU. The processor 50 is connected to the control unit 20 of the scanner 2, the control unit 30 of the printer 3, and the control unit 40 of the operation panel 4 via the interface.

The RAM 52 functions as a working memory or a buffer memory. The ROM 51 is a non-rewritable nonvolatile memory. The ROM 51 functions as a program memory that stores a program. The processor 50 executes various processing functions by executing the programs stored in the ROM 51 or the storage device 53 using the RAM 52.

The storage device 53 is a rewritable nonvolatile memory. For example, the storage device 53 is configured with a hard disk drive (HDD) or a solid-state drive (SSD). The storage device 53 stores data such as control data, a control program, or setting information.

The storage device 53 includes storage areas 531, 532, and 533. The storage area 531 stores various programs. For example, the storage area 531 stores a voice recognition program for recognizing a content of a voice and a person identification (person recognition) program for specifying a speaker from a voice. The processor 50 recognizes a voice input through the microphone 6 or the like by executing the voice recognition program. In addition, the processor 50 executes personal (authentication) identification for specifying a person who outputs the input voice by executing the person identification program.

The storage area 532 stores a user information database that stores information (user information) regarding pre-registered users (registrants). The storage area 533 stores a registration function database that stores information regarding a function that is executed by voice recognition set by a registrant. The user information stored in the storage area 532 and the information stored in the storage area 533 will be described below in detail.

The communication interface 54 is an interface for data communication with an external apparatus. For example, the communication interface 54 communicates with a user terminal such as a PC or a mobile terminal via a network. The communication interface 54 may input voice information from a user terminal such as a PC, the voice information instructing to execute a job such as image printing (print job).

The interface 55 connects the microphone 6 that inputs a voice. The interface 55 is an example of the voice input interface. The interface 55 is an interface for acquiring the voice (input voice) input through the microphone 6. The processor 50 acquires the voice input to the microphone 6 via the interface 55. If the microphone is a microphone 106 connected to a user terminal 101, the communication interface 54 functions as a voice input interface.

The interface 56 connects the speaker unit 7 that outputs a voice. The interface 56 is an example of the voice output interface. The interface 56 is an interface for outputting a voice signal of the voice output from the speaker unit 7. The processor 50 outputs the voice signal of the voice output from the speaker unit 7 via the interface 56. If the speaker unit is a speaker unit 107 connected to the user terminal 101, the communication interface 54 functions as the voice output interface.

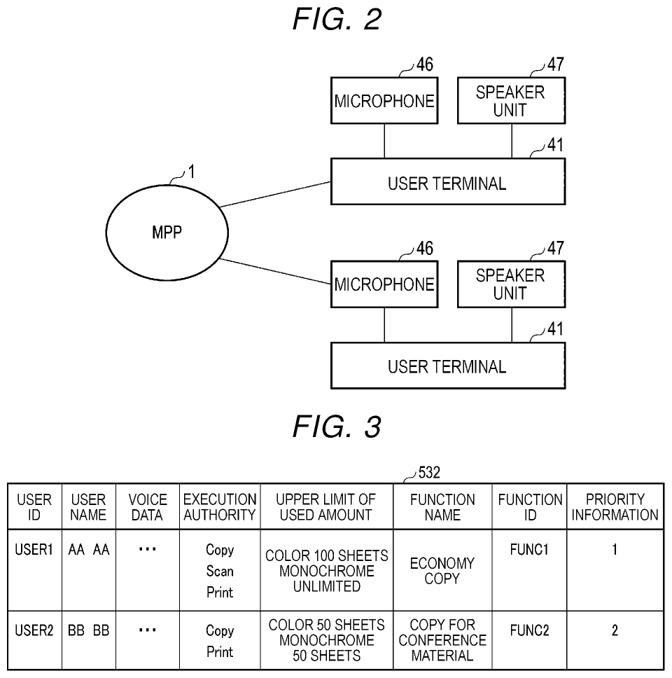

FIG. 2 is a diagram schematically illustrating a configuration example of a processing system where the user terminal 101 is connected to the digital multi-functional peripheral 1.

In the network system illustrated in FIG. 2, a plurality of user terminals 101 are connected to the digital multi-functional peripheral 1. Each of the user terminals 101 may be a personal computer (PC) or may be a mobile terminal such as a smartphone or a tablet PC. The user terminal 101 includes the microphone 106 and the speaker unit 107. The microphone 106 and the speaker unit 107 may be included in the user terminal 101 or may be connected to the user terminal 101 via the interface.

The digital multi-functional peripheral 1 receives an execution instruction of a job from each of the user terminals 101. For example, the digital multi-functional peripheral 1 acquires an execution instruction of a job from a voice input to the microphone 106 of the user terminal 101. In addition, the digital multi-functional peripheral 1 may output an execution content of a job by voice from the speaker unit 107 depending on a recognition result of the voice input to the microphone 106 of the user terminal 101.

Next, the operation of the voice recognition of the digital multi-functional peripheral 1 as the image forming apparatus according to the embodiment will be described.

FIG. 3 is a diagram illustrating a configuration example of the user information database (DB) stored in the storage area 532 by the digital multi-functional peripheral 1.

The user information stored in the user information database of the storage area 532 is information regarding a registrant who gives an execution instruction of an operation (job) to the digital multi-functional peripheral by voice. The digital multi-functional peripheral 1 permits the execution of the job by the voice instruction for the user whose user information is registered in the user information database. In addition, the digital multi-functional peripheral 1 has a function of restricting a process to be permitted for a user based on the information stored in the user information DB.

In the example illustrated in FIG. 3, the user information database stores information such as a user ID, a user name, voice data, an execution authority, an upper limit of a used amount, a function ID, a function name, or priority as the user information per user.

The user ID is identification information for identifying the user. The user name is the name of the user. The voice data is voice data for person identification for identifying the user from the input voice. The voice data may be characteristic data of the voice extracted from the voice. The execution authority is information representing a function that is permitted to be executed by the digital multi-functional peripheral 1 for the user. The upper limit of the used amount is information representing a used amount or a use condition that is permitted for the user.

The function ID and the function name are information representing a function (voice execution function) that is executed by a voice registered by the user. The function ID is identification information for identifying the voice execution function registered by the user. The function name is the name of the voice execution function registered by the user. The priority is information representing priority relating to execution of a job instructed by the user. The priority may be a serially set priority order or may be information (for example, a group name or a position) for determining the priority order.

For example, a user whose user ID is “USER1” has a user name “AAAA”, and authorities for executing jobs such as copy, scan, or print. In addition, for the user “USER1”, the number of sheets for color printing is limited to 100 sheets, and the number of sheets for monochrome printing is not limited. Further, the user “USER1” registers a function having a function name “Economy Copy” and a function ID “FUNC1” as a function (registered function) that is registered to be executable by the voice instruction. In addition, since the priority of the user “USER1” is “1”, the job is preferentially executed prior to jobs of the other users.

In addition, in the example illustrated in FIG. 3, a user whose user ID is “USER2” has a user name “RBBB” and execution authorities for copy and print. In addition, for the user “USER2”, the number of sheets for color printing is limited to 50 sheets, and the number of sheets for monochrome printing is limited to 50 sheets. Further, the user “USER2” registers a function having a function name “Copy for Conference Material” and a function ID “FUNC2” as a function (registered function) that is registered to be executable by the voice instruction. In addition, since the priority of the user “USER2” is “2”, the execution order of the job is set to be the next to the job of the user having the priority “1”.

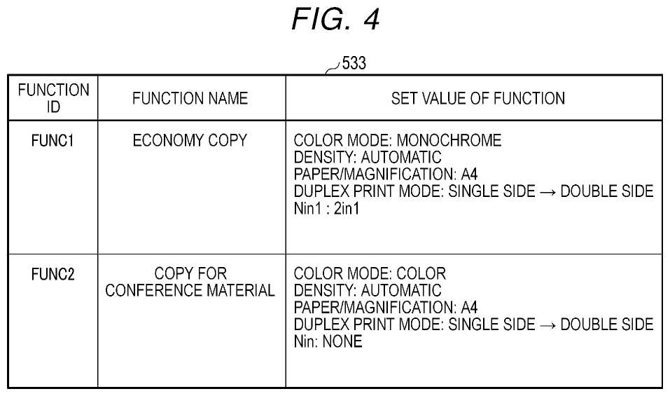

FIG. 4 is a diagram illustrating a configuration example of the function database (DB) stored in the storage area 533 by the digital multi-functional peripheral 1.

The function database stored in the storage area 533 illustrated in FIG. 4 stores information regarding a function (voice execution function) that is executable in the digital multi-functional peripheral 1 by a voice instruction from a user. The digital multi-functional peripheral 1 specifies the voice execution function to be executed based on the information registered in the function database in response to the voice instruction from the user specified by speaker identification based on voice.

In the example illustrated in FIG. 4, the function database stores information such as a function ID, a function name, and a set value. The function ID is identification information for identifying the voice execution function. The function name is the name of the voice execution function registered by the user. The set value is setting information representing the content of the voice execution function.

In the example illustrated in FIG. 4, the voice execution function having a function ID “FUNC1” has a function name “Economy Copy” and is a job of copying the execution content represented by the set value.

Specifically, in the set value of the function having the function ID “FUNC1”, the color mode is monochrome, the density is automatic, the paper is A4, the duplex printing mode is single side to double side, and the Nin1 mode is 2in1. As a result, the voice execution function having the function ID “FUNC1” is set as a copy job of printing an image of a document on both sides of the paper A4 in 2in1 with the automatic density setting of monochrome.

In addition, the function having a function ID “FUNC2” has a function name “Copy for Conference Material” and is a job of copying the execution content represented by the set value. Specifically, in the set value of the function having the function ID “FUNC2”, the color mode is color, the density is automatic, the paper is A4, the duplex printing mode is single side to double side, and the Nin1 mode is “None”. As a result, the voice execution function having the function ID “FUNC2” is set as a copy job of printing an image of a document on both sides of the paper A4 with the automatic density setting of color.

Next, a registration process of the voice execution function that is instructed to be executed in the digital multi-functional peripheral 1 from a user by voice will be described.

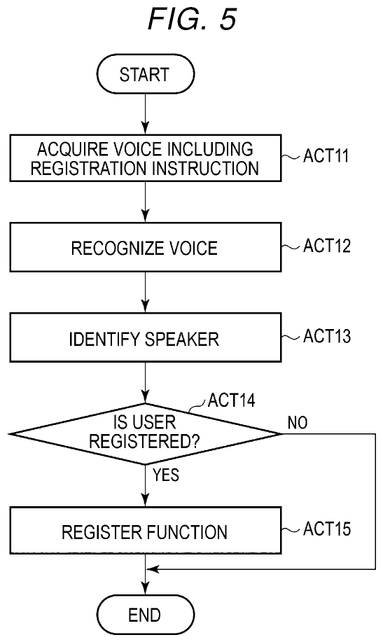

FIG. 5 is a flowchart illustrating an operation example of the registration process of the voice execution function that is executed in the digital multi-functional peripheral 1 by the voice of the user.

First, the processor 50 of the digital multi-functional peripheral 1 receives the registration process of the voice execution function for the user in response to the voice instruction from the user. The user whose user information is registered instructs the digital multi-functional peripheral 1 to execute the registration process of the function that is executed by voice in the digital multi-functional peripheral 1 through the microphone 6 or the microphone 106 of the user terminal 101. The digital multi-functional peripheral 1 acquires, as an input voice, the voice instruction to register the voice execution function output from the user. The digital multi-functional peripheral 1 recognizes the input voice, recognizes the registration instruction of the voice execution function, and registers the recognized content as the voice execution function.

The processor 50 acquires the voice (input voice) including the registration instruction of the voice execution function input to the microphone 6 (or the microphone 106) by the user (ACT 11). If the input voice is acquired, the processor 50 executes voice recognition and person identification on the input voice.

That is, the processor 50 recognizes the content of the input voice by executing the voice recognition program (ACT 12). The processor 50 executes a process corresponding to the content of the input voice recognized by voice. Here, it is assumed that the content of the input voice acquired in ACT 11 is the registration instruction of the voice execution function.

In addition, the processor 50 identifies a speaker of the input voice by executing the person identification program (ACT 13). Here, it is assumed that the processor 50 specifies which user registered in the user information database is the speaker of the input voice. For example, the processor 50 calculates a similarity between feature data of the input voice and feature data of the voice data (voice data for person identification) of each of the users registered in the user information database. If the similarity between the feature data of the input voice and the feature data of the voice data is a predetermined value or more, the processor 50 determines that the user of the voice data is the speaker of the input voice.

If the processor 50 cannot specify that the speaker of the input voice is the user whose voice data is registered in the user information database (ACT 14, NO), the processor 50 ends the registration process of the function.

If the processor 50 specifies that the speaker of the input voice is the user whose voice data is registered in the user information database (ACT 14, YES), the processor 50 executes the registration of the voice execution function for the user (ACT 15). For example, the processor 50 acquires an input voice including a content of a voice execution function that is output to the microphone 6 by the user. The processor 50 recognizes the content of the voice execution function output by the user by executing the voice recognition program.

The processor 50 specifies the content of the voice execution function that is instructed to be registered by the user based on the recognition result of the input voice. If the content of the specified voice execution function is a function that is executable by the user, the processor 50 issues a function ID for the voice execution function. The processor 50 registers the issued function ID and a function name in the user information database as the user information of the user. In addition, the processor 50 determines a set value representing the content of the specified voice execution function, correlates the function ID and the function name with each other, and registers the set value representing the content of the voice execution function in the function database.

For example, it is assumed that the registered user outputs a voice “register the function in MFP”, “the function name is “Economy Copy”, both sides, monochrome, register in 2in1” to the microphone 6. As a result, the processor 50 collects the voice “register the function in MFP” output to the microphone 6 by the user through the microphone 6, and inputs the voice collected through the microphone 6 as the input voice. The processor 50 recognizes the content of the input voice is “register the function in MFP” by executing the voice recognition program. In addition, the processor 50 specifies a user who is the speaker of the input voice by executing the person identification program.

Further, the processor 50 specifies that the content of the voice execution function is “the function name is “Economy Copy”, both sides, monochrome, register in 2in1” from the input voice by the voice recognition. If the content of the specified voice execution function is a function that is executable by the user, the processor 50 issues a function ID. The processor 50 correlates the issued function ID and a function name with the user and registers the correlated information in the user information database. In addition, the processor 50 correlates the set value representing the content of the specified voice execution function with the function ID and the function name, and registers the correlated information in the function database.

Next, the operation in which the digital multi-functional peripheral 1 as the image forming apparatus according to the embodiment executes a process in response to the voice instruction from the user will be described.

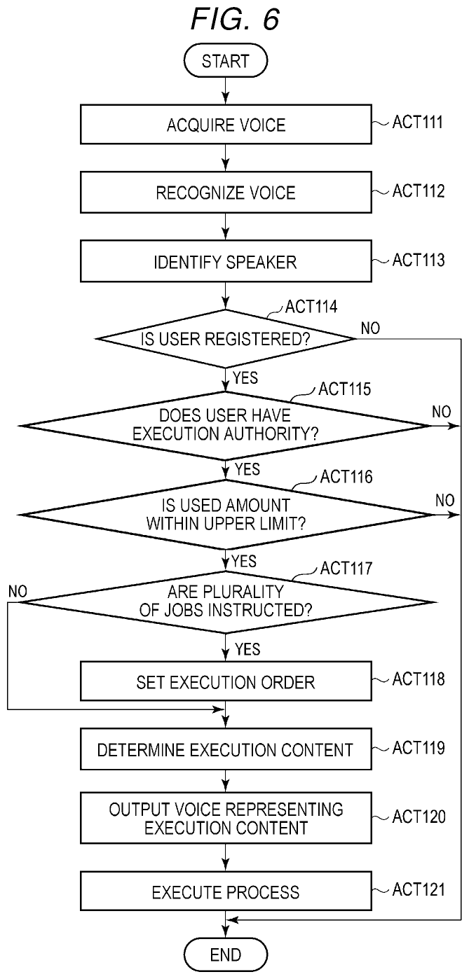

FIG. 6 is a flowchart illustrating an operation example in which the digital multi-functional peripheral 1 as the image forming apparatus according to the embodiment executes various functions in response to the voice instruction from the user.

The processor 50 of the digital multi-functional peripheral 1 executes a process of a job instructed by each user in response to the voice instruction from the user. The user whose user information is registered outputs a job that is executed in the digital multi-functional peripheral 1 to the microphone 6 or the microphone 106 of the user terminal 101 by voice. The digital multi-functional peripheral 1 acquires, as an input voice, the voice instruction to execute the job output from the user. The digital multi-functional peripheral 1 recognizes the input voice, recognizes the content of the voice instruction, and receives the execution instruction of the job as the recognized content.

The processor 50 acquires the voice (input voice) including the execution instruction of the job input to the microphone 6 (or the microphone 106) by the user via the interface 55 (ACT 111). For example, the user instructs the content of the job by voice. Specifically, the user instructs the content of the job by voice by outputting a voice “both sides, monochrome, copy in 2in1”. In addition, the user may instruct execution of a function registered as the voice execution function by voice. For example, by outputting a voice “Economy Copy”, the user may instruct execution of the voice execution function of which the function name is registered as “Economy Copy” by voice.

If the input voice is acquired via the interface 55, the processor 50 executes voice recognition and person identification on the input voice. The processor 50 recognizes the content of the input voice by executing the voice recognition program (ACT 112). Here, it is assumed that the content of the input voice acquired in ACT 11 is the execution instruction of the job.

In addition, the processor 50 identifies a user (speaker) of the input voice by executing the person identification program (ACT 113). For example, the processor 50 identifies the speaker based on a similarity between feature data of the input voice and feature data of the voice data (voice data for person identification) of each of the users registered in the user information database.

If the processor 50 cannot specify that the speaker of the input voice is the user registered in the user information database (ACT 114, NO), the processor 50 does not receive the execution of the job. However, even for an unregistered user (user that is not recognized as a registered user), the processor 50 may receive execution of a job of a specific function. In this case, if the content of the job recognized from the input voice is a job content that is permitted for an unregistered user, the processor 50 may execute subsequent processes after ACT 115.

If the processor 50 specifies that the speaker of the input voice is the user whose voice data is registered in the user information database (ACT 114, YES), the processor 50 checks an execution authority of the user (ACT 115). The processor 50 determines whether or not the content of the job recognized from the input voice includes a function for which the user does not have the execution authority. For example, if the content of the job recognized from the input voice includes a function for which the user does not have the execution authority, the processor 50 determines that the user does not have the execution authority for the job. If the processor 50 determines that the user does not have the execution authority (ACT 115, NO), the processor 50 stops execution of the job instructed by the input voice.

If the processor 50 determines that the user has the execution authority for the job instructed by voice (ACT 115, YES), the processor 50 determines whether or not the used amount of the job instructed by voice is within an upper limit set for the user (ACT 116). The processor 50 calculates the used amount of the user if the job instructed by voice is executed. The processor 50 determines whether or not the calculated used amount is within the upper limit of the used amount set for the user. If the processor 50 determines that the used amount exceeds the upper limit after the execution of the job instructed by voice (ACT 116, NO), the processor 50 stops the execution of the job instructed by voice.

If the processor 50 determines that the used amount is within the upper limit even after the execution of the job instructed by voice (ACT 116, YES), the processor 50 determines whether or not a plurality of jobs are instructed from a plurality of users in the same period (ACT 117). It is assumed that, if a job is instructed by voice, another job is instructed from another user before the voice instruction is not completed.

For the voice instruction of the job to the digital multi-functional peripheral 1, a period of time is required until speech of one user ends from the start of the speech. On the other hand, the processor 50 of the digital multi-functional peripheral 1 recognizes voices output by a plurality of users in the same period on a user by user basis. As a result, even if a plurality of users instructs jobs by voice in the same period, the digital multi-functional peripheral 1 can receive the voice instructions of the jobs from the plurality of users.

If a plurality of jobs input from a plurality of users by voice in the same period are received (ACT 117), the processor 50 sets a processing order (execution order) for executing the plurality of jobs (ACT 118). As the processing order in which the plurality of jobs instructed by the plurality of speakers in the same period are executed, the processor 50 sets an execution order of processes to be executed concurrently and an execution order of processes to be executed serially.

The processor 50 specifies concurrently executable processes among the plurality of jobs. The processor 50 sets a processing order of the plurality of jobs so as to concurrently execute the concurrently executable processes. For example, the processor 50 sets the processing order so as to concurrently execute a process using the scanner 2 (scan job) and a process using the printer 3 (print job). If a first user instructs the scan job by voice instruction, the processor 50 sets the execution order to execute the print job instructed by a second user in the same period concurrently with the scan job of the first user.

In addition, the processor 50 sets the execution order for the process to be executed serially among the plurality of jobs. For example, a plurality of print jobs instructed from a plurality of users cannot be executed concurrently because one printer is used. Therefore, the processor 50 sets the execution order to serially execute the plurality of print jobs instructed from the plurality of users.

The processor 50 sets the execution order based on the priority set for each of the users who instructs the plurality of jobs by voice. In the example illustrated in FIG. 3, the priority of the user (referred to as “user 1”) whose user ID is “USER1” is “1”, and the priority of the user (referred to as “user 2”) whose user ID is “USER2” is “2”. Therefore, the user 1 and the user 2 instruct jobs to be executed serially in the same period by voice, the processor 50 sets the execution order to execute the job of the user 2 next to the job of the user 1.

In addition, the processor 50 determines an execution content for each of the jobs received by the voice instruction (ACT 119). If a job is received from one user, the processor 50 sets the execution content of the job based on the content of the voice instruction by the user, default settings, and the like.

In addition, if a plurality of jobs are received from a plurality of users, the processor 50 determines the execution content of each of the jobs such that each of the jobs can easily understand the execution results of the plurality of jobs. For example, if a plurality of print jobs are received from a plurality of users in the same period, the processor 50 sets an output method of paper for the print job of each of the users.

In a specific example, if the printer 3 includes a plurality of output trays, the processor 50 sets the execution content of each of the jobs such that the results of the print jobs of the users are output to different output trays, respectively. As a result, the results of the print jobs instructed from the plurality of users in the same period can be output to the different output trays, respectively. In addition, if an output tray of the printer 3 is configured to be movable, the processor 50 sets the execution content of each of the jobs such that the output tray moves whenever the result of the print job of each of the users is output. As a result, the results of the print jobs instructed from the plurality of users in the same period can be output to different positions (or different directions) on the output tray.

After determining the execution content of each of the jobs received by the voice instruction, the processor 50 outputs a voice representing the execution content from the speaker unit 7 (ACT 120). For example, if the processor 50 determines the execution contents for the plurality of jobs instructed from the plurality of users in the same period, the processor 50 outputs a voice representing the execution order and the execution contents of the jobs from the speaker unit 7. As a result, the users who instruct the jobs by voice can check the contents of the jobs to be executed based on the voice recognition results by voice.

In addition, after determining the execution content of each of the jobs received by the voice instruction, the processor 50 executes the jobs including the set execution contents in the set execution order (ACT 121).

According to the above-described process, the digital multi-functional peripheral according to the embodiment recognizes the content of the job instructed by voice from the input voice, and identifies the user of the input voice. If voice instructions output from a plurality of users in the same period are acquired, the digital multi-functional peripheral sets the execution order for a plurality of jobs instructed from the plurality of users by voice.

As a result, in the embodiment, even if a plurality of users execute voice instructions in the same period, jobs instructed by the users can be smoothly executed.

In addition, the digital multi-functional peripheral according to the embodiment sets the execution order to concurrently execute concurrently executable processes among a plurality of jobs instructed from a plurality of users in the same period by voice. As a result, even if a plurality of jobs are instructed from different users, the plurality of jobs can be smoothly processed by concurrently executing concurrently executable processes.

In addition, the digital multi-functional peripheral according to the embodiment sets the execution order for a plurality of jobs instructed from a plurality of users in the same period by voice based on the priority set for each of the users. As a result, the plurality of jobs instructed from the plurality of users can be executed in the preset order of priority, the plurality of jobs can be smoothly processed.

In addition, the digital multi-functional peripheral according to the embodiment is set to output, using different output methods, results of a plurality of jobs instructed from a plurality of users in the same period by voice. As a result, the plurality of jobs instructed from the plurality of users in the same period by voice can be easily distinguished from each other per user.

In addition, the digital multi-functional peripheral according to the embodiment may set the upper limit of the number of executable times for a plurality of jobs recognized by voices output from a plurality of speakers in the same period. If the number of execution times of a plurality of jobs recognized from voices output from a plurality of speakers in the same period exceeds the upper limit, the processor 50 may disable execution of jobs corresponding to a difference from a predetermined number of times.

In this case, the processor 50 outputs the disabled jobs from the speaker unit 7 via the interface 56 by voice. In addition, the processor 50 may cause the display unit or the like of the operation panel 4 to display information representing the disabled jobs. In addition, the processor 50 may record information representing the disabled jobs in a storage device or the like as log information.

As a result, the users can recognize the jobs that are disabled because the number of execution times exceeds the upper limit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a voice input interface configured to acquire an input voice input through a microphone;
a processor configured to
recognize a content of a job instructed by voice from the input voice acquired by the voice input interface,
identify a speaker from the input voice,
if voices output from a plurality of speakers in the same period are acquired, set an execution order of a plurality of jobs that are recognized from the voices output from the plurality of speakers, and
execute the jobs in the set execution order.

2. The image forming apparatus according to claim 1,
wherein the processor sets an execution order so as to concurrently execute concurrently executable processes among the jobs.

3. The image forming apparatus according to claim 1,
wherein the processor sets an execution order of the jobs based on a priority set for each of the plurality of speakers.

4. The image forming apparatus according to claim 1,
wherein if the jobs include a plurality of print jobs, the processor sets different paper discharge methods for the print jobs.

5. The image forming apparatus according to claim 1, further comprising a voice output interface configured to output a voice signal output from a speaker,
wherein the processor causes the speaker to output a voice via the voice output interface, the voice representing execution contents for the plurality of jobs that are recognized from voices output from the plurality of speakers in the same period.

6. The image forming apparatus according to claim 1, further comprising a user information database comprising registered user information.

7. The image forming apparatus according to claim 6,
wherein the registered user information comprises at least one of a user ID, a user name, voice data, an execution authority, an upper limit of a used amount, a function ID, a function name, and a priority per user.

8. A method for an image forming apparatus, comprising:
acquiring an input voice input through a microphone of a voice input interface;
recognizing a content of a job instructed by voice from the input voice acquired;
identifying a speaker from the input voice;
if voices output from a plurality of speakers in the same period are acquired, setting an execution order of a plurality of jobs that are recognized from the voices output from the plurality of speakers; and
executing the jobs in the set execution order.

9. The method according to claim 8, further comprising:
setting an execution order so as to concurrently execute concurrently executable processes among the jobs.

10. The method according to claim 8, further comprising:
setting an execution order of the jobs based on a priority set for each of the plurality of speakers.

11. The method according to claim 8, further comprising:
if the jobs include a plurality of print jobs, setting different paper discharge methods for the print jobs.

12. The method according to claim 8, further comprising:
outputting a voice signal output from a speaker of a voice output interface,
causing the speaker to output a voice via the voice output interface, the voice representing execution contents for the plurality of jobs that are recognized from voices output from the plurality of speakers in the same period.

13. The method according to claim 8, further comprising:
identifying the speaker from the input voice by correlating the input voice to a user information database comprising registered user information comprising at least one of a user ID, a user name, voice data, an execution authority, an upper limit of a used amount, a function ID, a function name, and a priority per user.

14. An image forming system, comprising:
an user terminal comprising:
a voice input interface configured to acquire an input voice input through a microphone;
a processor configured to
recognize a content of a job instructed by voice from the input voice acquired by the voice input interface,
identify a speaker from the input voice,
if voices output from a plurality of speakers in the same period are acquired, set an execution order of a plurality of jobs that are recognized from the voices output from the plurality of speakers, and
execute the jobs in the set execution order; and
an image forming apparatus comprising:
a scanner,
a printer, and
a controller for executing scanning, executing printing, and communicating with the user terminal.

15. The image forming system according to claim 14,
wherein the processor sets an execution order so as to concurrently execute concurrently executable processes among the jobs.

16. The image forming system according to claim 14,
wherein the processor sets an execution order of the jobs based on a priority set for each of the plurality of speakers.

17. The image forming system according to claim 14,
wherein if the jobs include a plurality of print jobs, the processor sets different paper discharge methods for the print jobs.

18. The image forming system according to claim 14, further comprising a voice output interface configured to output a voice signal output from a speaker,
wherein the processor causes the speaker to output a voice via the voice output interface, the voice representing execution contents for the plurality of jobs that are recognized from voices output from the plurality of speakers in the same period.

19. The image forming system according to claim 14, wherein the image forming apparatus further comprises a user information database comprising registered user information.

20. The image forming system according to claim 19,
wherein the registered user information comprises at least one of a user ID, a user name, voice data, an execution authority, an upper limit of a used amount, a function ID, a function name, and a priority per user.
